(19) United States
(12) Patent Application Publication
(10) Pub. No.: US 2010/0035069 A1
(43) Pub. Date: Feb. 11, 2010

(54) Hydrophobic lens coating

(76) Inventors: Zhi Chao Li, Nanyang City (CN); Tian Zhou Wang, Nanyang City (CN)

Correspondence Address: Timothy E Siegel Patent Law, PLLC, 601 108th Avenue, Suite 1900, Bellevue, WA, 98004, US

(21) Appl. No.: 11/821,092

(22) Filed: Jun. 20, 2007

(51) Int. Cl. B32B 9/04

(52) U.S. Cl. 428/447

(57) ABSTRACT

A lens and a method of manufacturing a lens including a substrate, a first anti-reflective (AR) coating on the substrate, a hard coating (HC) material on the AR layer, a hydrophobic material deposited on the HC layer; and the coated substrate having a reflectance that is lower than the reflectance of the HC material.

### BACKGROUND OF THE INVENTION

This application is directed toward a composite coating for a surface of a lens to minimize fogging or distortion resulting from moisture condensing on the lens, while at the same time preserving a high degree of light transmission through the lens. Such coatings as now practiced in the art normally include multiple layers, including a first anti-reflective (AR) coating and a durable hydrophobic coating over the AR coating.

Sportsmen, military and law enforcement agencies routinely use binoculars and rifle scopes mounted on a firearm. It is often the case that moisture condenses or collects on an exterior surface of the lens, which clouds or distorts the image. This can occur if the user's breath contacts the lens, or when it is raining.

There are materials that can be applied to lens surfaces to render them hydrophobic and promote the beading of water on the surface to prevent a moisture layer from forming on the lens. Certain of these treatments are appropriate for applications such as car windshields and sunglasses, for example, but not for more demanding applications of precision optics as found in scopes and binoculars since such treatments reduce the light transmission to a degree that is unacceptable in such applications. Accordingly, a number of composite hydrophobic coatings have been developed that attempt to meet the requirements of more demanding applications, and with some success. Such prior art coatings decrease reflection and avoid a significant decrease in the transmission of light through the lens.

Coatings known in the prior art have not succeeded in meeting all of the requirements of the more demanding applications. For example, in some instances an anti-reflective (AR) layer is first applied to the lens surface and a hydrophobic layer is then applied over the AR layer. However, the hydrophobic layer often will not tightly adhere to the AR layer. In addition, even if the hydrophobic layer will adhere to a particular AR layer, it has been found through testing that the hydrophobic layer is not sufficiently abrasion resistant, and can be easily damaged or removed during normal use. The removal of the hydrophobic layer then exposes the AR layer to abrasion and the resulting degradation. A hard coating layer can be interspersed between the hydrophobic layer and the AR layer to protect the AR layer. However, it is generally believed in the art that an acceptable hydrophobic layer must not decrease the degree of light transmission through the lens.

Consequently, it is desirable to provide an overall coating for an exterior face of a riflescope lens or the like, which includes an externally located hydrophobic polymer that transmits light in the visible range and causes quick beading and sloughing of moisture from the lens. Furthermore, an anti-reflective component is required to allow almost one hundred percent of visible light at selected wavelengths to be transmitted through the lens and the hydrophobic polymer. It is important that the hydrophobic coating be strongly adhered to the lens and not easily removed by rubbing or wear over time. A hydrophobic lens coating is required that embodies a certain hardness or durability to protect the lens or any AR layers located on the lens such that the coating is not easily scratched. In this respect, it is desirable that the hydrophobic lens coating be of sufficient hardness and durability to undergo conventional testing without significant damage to the hydrophobic coating, any AR coating, or the lens itself. Accordingly, references in the art teach that a hydrophobic material that increases the reflectivity of the composite layer is not an acceptable material for use as a hydrophobic coating. Many different types of anti-reflective layers have been developed for various lenses and for various purposes. As described in U.S. Pat. No. 6,906,862 B2, for example, light that has a wavelength of 550 nm and is approximately in the middle of the visible range is typically considered to be an important wavelength to be transmitted through the lens. Therefore, the AR layer is normally deposited in a thickness related to the 550 nm wavelength. As an example, a common coating that is three sub-layers in thickness is often deposited in layers that are ¼, ½ and ¼ of the length of the wave of the wavelength or 140 nm, 220 nm, and 140 nm in thickness. The art associated with production of anti-reflective coatings and how to deposit such coatings on articles is well known to those having ordinary kills in the art. Anti-reflective layers are described in such references as the Handbook of Optics by McGraw Hill, 2.sup.nd Ed., in Chapter 42, Dealing with Optical Properties of Films and Coatings, Design of Optical Interference Coatings by McGraw Hill Book Company in Chapter 4 on Anti-Reflection Coatings, as well as in issued U.S. patents to Kimura et al., U.S. Pat. No. 4,726,654, Akatuska et al., U.S. Pat. No. 4,784,467, and Tani, U.S. Pat. No. 4,387,960, which are all included here in reference.

However, in those applications the composite lens coatings described therein have not displayed an acceptable degree of hardness and abrasion resistance so as to render the lens coatings sufficiently durable for the more demanding uses discussed above. In addition, those of skill in the art have rejected some known hydrophobic polymeric materials because they tend to reduce the overall light transmission of the lens.

A need therefore exists for a lens coating that includes an AR layer and a hydrophobic outer surface, and which embodies greater hardness and abrasion resistance than can be achieved with known lens coatings.

### BRIEF DESCRIPTION OF THE DRAWING

FIG. 1 is a partial cross-sectional schematic view of a first embodiment of the invention.

FIG. 2 is a schematic cross-sectional schematic view of a second embodiment of the invention.

FIG. 3 is a graphical representation of reflectance values measured with respect to the second embodiment shown in FIG. 2.

### DETAILED DESCRIPTION OF THE INVENTION

While preferred embodiments of the invention are described in detail, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

In one embodiment of the invention a glass substrate is first coated with an AR layer. A hard coating (HC) layer is then applied over the AR layer, and finally a hydrophobic layer is applied over the HC layer. Applicant has discovered that by the appropriate selection of the HC and hydrophobic layers, an acceptably low degree of reflectance can be achieved while imparting an unexpected level of hardness and abrasion resistance to the surface. This is the case even though HC layers are generally known to be more reflective than would otherwise be acceptable in the more demanding optical applications.

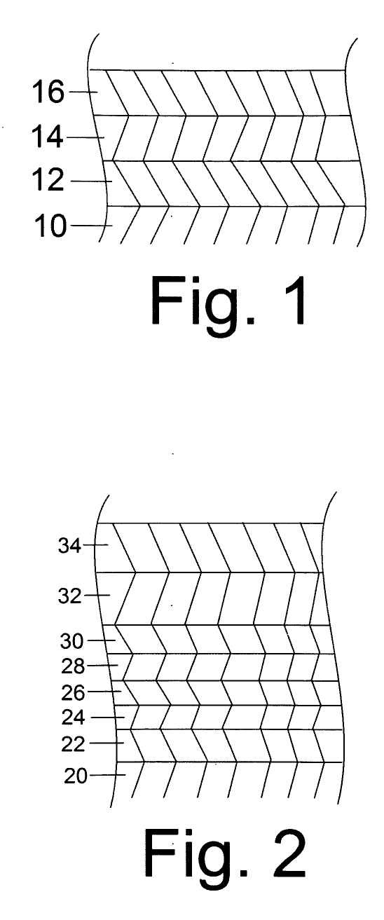

In one preferred embodiment of the invention shown in FIG. 1 a low index AR layer 12 of SiO₂ or MgF₂ is first deposited on the surface of the substrate 10. The AR layer has a thickness of about 90-120 nm and an Nd of between about 1.38 and 1.50. An HC layer 14 of Ta₂O₅ is then deposited over the AR layer to a thickness of about 90-120 nm. The Nd of the HC layer is between about 1.80-2.30. A hydrophobic organic silane layer 16 is then deposited over the HC layer to a thickness of about 5-20 nm.

In a second embodiment alternating layers of low index AR material (22, 26, 30) such as SiO₂ and MgF₂ and high index AR material (24, 28) such as TiO2 or ZrO₂ are deposited on the surface of the substrate. The low index AR layers each have a thickness of about 90-120 nm and an Nd of between about 1.38 and 1.50. The high index AR layers each have a thickness of about 90-120 nm, and an Nd of between about 1.80 and 2.30. An HC layer 32 of Ta₂O₅ is then deposited over the AR layer to a thickness of about 90-120. The Nd of the HC layer is between about 1.80-2.30. As in the first embodiment a layer of hydrophobic organic silane layer 34 is then deposited over the HC layer to a thickness of about 5-20 nm.

In another example of a lens and coating according to the invention, a composite coating is formed on a glass substrate and includes a high reflectivity ZrO₂ layer, a low reflectivity MgF₂ layer, a hard coating layer of SiO₂ and a hydrophobic layer of silicone resin. The layers are deposited sequentially in a vacuum coating chamber. In this example a substrate of BK7 glass is first cleaned ultrasonically, placed in jigs and positioned in a vacuum chamber. The vacuum chamber preferably includes one or more heating mechanisms, preferably including both an electron beam crucible and a thermal resistance evaporative heater. ZrO₂, MgF₂, SiO₂ and silicone resin are placed in the chamber, each in a separate vessel associated with one of the heating mechanisms. The chamber is first pumped down to a pressure of no more than about 5×10⁻³ Pa. The substrate is heated to about 200 degrees C. The ZrO₂ is then heated and vaporized and deposited onto the glass substrate to a thickness of between about 200-270 nm. The ZrO₂ is then cooled, and any residual ZrO₂ is evacuated from the chamber. The MgF₂ is then heated and deposited over the ZrO₂ layer to a thickness of between about 60-90 nm. The MgF₂ is cooled and any residual MgF₂ is evacuated from the chamber. The SiO2 is then heated and vaporized and deposited over the MgF₂ layer to a thickness of about 10-30 nm. The SiO₂ is cooled, and any residual SiO₂ vapor is evacuated from the chamber. Finally the hydrophobic silicone resin is heated and vaporized and deposited over the SiO₂ hard coating layer. The coated substrate is cooled and then removed from the vacuum chamber and the coated lens is complete.

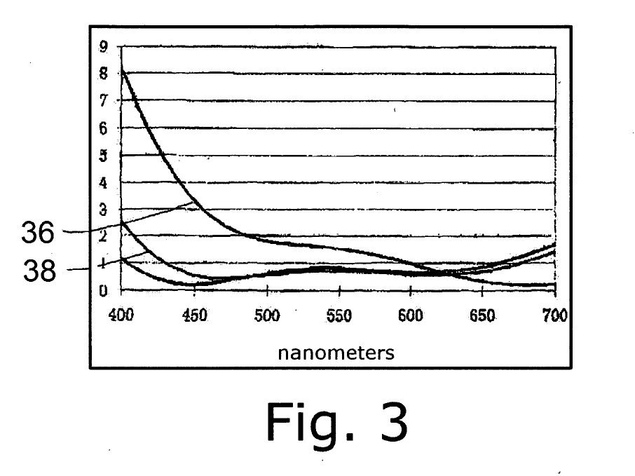

The overall reflectance of a lens prepared according to the second embodiment described above was measured and is shown graphically in FIG. 3 for wavelengths between 400 and 700 nm. The reflectance of a coated lens was measured before and after application of the HC layer and again before and after depositing the hydrophobic layer. The reflectance measurements are shown Table 1 for the second embodiment (i.e. 5 AR layers) described above. The measurements are shown graphically in FIG. 3.

The expected outcome of these measurements was an increase in reflectance of the lens after application of the HC layer (line 36, FIG. 3). The unexpected and surprising result was a dramatic decrease in the reflectance of the lens after application of the hydrophobic layer over the HC layer (line 38, FIG. 3). In this embodiment the reflectance of the lens after application of the hydrophobic layer was reduced to almost the level of the lens after the AR layers were applied but before the HC layer was applied. In particular the average reflectance between 400 and 700 nm was measured at about 1.99% after application of the hard coating layer. After application of the hydrophobic layer the reflectance was reduced to an average of 0.81% over the same wavelength range. This result is not what one skilled in the art would expect from prior art references, and now permits a highly hydrophobic lens to be produced which also embodies a very low reflectance.

A lens produced in accordance with the second embodiment of the invention described above present was tested for durability. The standard eraser test was performed using an eraser insert complying with military specification MIL-E-12397B. The eraser was pressure fitted into the tester before performing the test. For the test, a lens having a hydrophobic coating in accordance with the present invention was tested by pressing the eraser against the lens at a pressure of 2.5 pounds. This pressure is indicated on the indicator rod of the body of the tester containing the eraser insert. The surface of the lens was rubbed with 20 strokes of the eraser wherein each stroke was about one inch in length. All strokes were made on one path. The lens was then washed with acetone and inspected for deterioration of the coating. No visible deterioration was detected after placing a drop of water on the area of the lens which had been rubbed with the eraser. Further testing of the contact angles of the water drop would confirm that the lens with the coating retained at least 95% of its hydrophobic characteristics after undergoing the test. Depending upon the method of applying the hydrophobic coating, the coatings will retain between 95-100% of their hydrophobic characteristics after undergoing the standard eraser test. Another method of testing the retention of hydrophobic characteristics as well as durability of the coating generally includes the step of performing the standard eraser test (as described above) and marking the lens in a direction transverse to the eraser strokes. The marking of the lens is generally done with a marker whereupon a strip of adhesive tape is placed over the mark and then removed. Preferably, at least 95% of the mark should be removed by the tape and the present invention exceeds this benchmark.

A second test of durability is performed according to MIL-C-675C and MIL-F48616. For this test, a strip of tape approximately 1.5 inches in length has approximately half of its length pressed onto the coated surface to be tested. The other half of the tape is held at an angle away from the surface and the pressed portion of the tape is pulled up quickly. The coating of the present invention passed this test as no coating was removed after the tape was lifted. Similarly, a second test was performed according to MIL-M-13508. For this test, approximately one inch of tape was placed over a portion of the coated surface such that the tape overlapped an edge of the object which was coated. The tape was pressed down on the coated surface as well as over the edge and then slowly removed. The coating of the present invention also passed this test as no coating was removed after the tape was lifted.

A third test of durability tests for crosshatch adhesion of the anti-reflective layer and the hydrophobic layer. To perform the test, a lens having an anti-reflective layer and a hydrophobic layer in accordance with the present invention was cleaned. A blade was used to make 6 incisions towards the edge of the lens. Six additional incisions were then made perpendicular to the first 6 incisions so that the combination of the incisions resembled a grid pattern. The dust and particles were removed from the grid with compressed air and the lens was inspected to ensure that the grid contained no chips and that the incisions were even. Adhesive tape (Scotch #600, 3M) was then applied over the cross hatch pattern with one end of the tape extending past the edge of the lens by at least ½ inches. The tape was pressed against the lens to remove any air bubbles trapped between the lens and the tape. Within 90 seconds (+−0.30 seconds), the adhesive tape was removed by holding the lens firmly, grasping the extended end of the tape and pulling it rapidly to the other side of the lens as close to an angle of 180.degree. as possible. The entire operation was repeated two more times over a testing period of 24 hours for each of the 10 lenses tested.

While the invention has been described by reference to the described embodiments, the invention is not limited to any particular embodiments described. Those of skill in the art will appreciate that the embodiments described above can be modified in arrangement and detail without departing from the scope of the following claims.

1. A coated transparent substrate comprising:
a substrate;
a first anti-reflective (AR) coating on the substrate; and,
a hard coating (HC) material on the AR layer;
a hydrophobic material deposited on the HC layer; and,
the coated substrate having a reflectance that is lower than the reflectance of the HC material.

2. A coated transparent substrate according to claim 1 wherein the HC material comprises Ta₂O₅.

3. A coated transparent substrate according to claim 1 wherein the hydrophobic material comprises an organic silane.

4. A coated transparent substrate according to claim 1 wherein the substrate, the AR layer and the HC layer exhibit a composite reflectance of between about 2%, and the substrate, the AR layer, the HC layer, and the hydrophobic layer exhibit a composite reflectance of about 0.8%.

5. A coated transparent substrate according to claim 1 wherein the AR layer comprises a low index AR material selected from the group consisting of SiO2 and MgF₂.

6. A coated transparent substrate according to claim 5 further wherein the AR layer further comprises at least one layer of a high index AR material selected from the group consisting of TiO₂ and ZrO₂.

7. A coated transparent substrate according to claim 6 wherein the AR layer between the substrate and the HC layer comprises a plurality of layers of low index AR material and high AR material.

8. A coated transparent substrate according to claim 6 wherein the AR layer between the substrate and the HC layer comprises a plurality of alternating layers of low index AR material and high AR material.

9. A coated transparent substrate according to claim 8 wherein the AR layer comprises a first layer of low index AR material adjacent the substrate, a second layer of high index AR layer atop the first AR layer, a third layer of low index AR material atop the second AR layer, a fourth layer of high index AR material atop the third AR layer, and a fifth layer of low index AR material between the fourth layer of AR material and the layer of HC material.
